(19) United States
(12) Patent Application Publication
(10) Pub. No.: US 2002/0131841 A1
(43) Pub. Date: Sep. 19, 2002

(54) Self-tapping fastner and method for attaching weatherseals

(75) Inventors: David Harold Berry, Northville, MI (US); John Seed, Shakespeare (CA); Tadeusz Rekret, Stratford (CA)

Correspondence Address: Timothy E. Nauman, Esq., Fay, Sharpe, Fagan, Minnich & McKee, LLP, 1100 Superior Avenue, 7th Floor, Cleveland, OH, 44114-2518, US

(73) Assignee: THE STANDARD PRODUCTS COMPANY

(21) Appl. No.: 09/808,524

(22) Filed: Mar. 14, 2001

(51) Int. Cl. F16B 25/00

(52) U.S. Cl. 411/386

(57) ABSTRACT

A self-tapping fastener or fastening peg secures a weatherseal to a mounting surface of an automotive vehicle. A pointed, conical nose pierces the weatherseal to form an opening. In the preferred embodiment, the fastening peg is rotated at a first velocity as it is axially advanced toward the weatherseal to create an opening. The fastening peg is further axially advanced and rotated at a second velocity to advance a first flange through the pierced opening, thereby securing the fastening peg to the weatherseal. The weatherseal is then secured to a vehicle mounting surface by advancing a locking assembly through a pre-formed opening in the mounting surface.

### BACKGROUND OF THE INVENTION

1. Field of the Invention

The present invention relates to a fastener, and more particularly to a self-tapping fastener for securing an elastomeric member, such as a weatherseal, to a mounting surface of a vehicle.

2. Discussion of the Art

It is generally known to use a fastener, peg, or clip for securing an elastomeric weatherseal to a mounting surface. For example, the following U.S. Pat. Nos. are generally related to fasteners of this type: 2,197,590; 2,061,970; 3,230,592; 4,363,160; 4,470,178; 5,011,356; 5,421,067; and 5,694,666.

A major problem associated with prior fasteners that affix the weatherseal to a mounting surface is the requirement that a hole or opening be separately formed in the weatherseal prior to inserting the fastener therein. This, of course, leads to increased costs and handling. The weatherseal is loaded into machinery that indexes the weatherseal to provide axially spaced, drilled openings in a base portion of the continuous strip weatherseal. In addition, the weatherseal with the drilled openings must then be properly indexed or coordinated with fastener installation machinery. As will be appreciated, the fasteners must be properly aligned with their associated openings and advanced through the opening to assure that the fastener or fastening peg is properly captured or secured to the weatherseal.

The weatherseal with the installed mounting pegs is subsequently secured to the mounting surface, such as the frame of an automotive vehicle, to accurately locate the weatherseal on the vehicle. For example, a base of the fastener peg includes a deflectable locking assembly that assists in automated installation of the weatherseal to the associated mounting surface. By merely axially advancing the fastener peg into an associated opening in the mounting surface the weatherseal is secured to the vehicle.

A need exists, therefore, for a more efficient, cost effective structure and procedure to attach weatherseals to vehicles.

### BRIEF SUMMARY OF THE INVENTION

An improved fastener or fastening peg for securing a weatherseal to a vehicle and a method of attaching a weatherseal to a vehicle are provided by the present invention.

A preferred embodiment of the fastening peg includes a pointed end or nose adapted to pierce an associated weatherseal. A flange or land substantially circumscribes the nose and is advanced through the opening pierced in the weatherseal to self-tap the fastening peg. A locking assembly is disposed in spaced relation from the flange to secure the fastening peg and weatherseal to an associated vehicle.

The flange is helically shaped and spirals radially, axially, and circumferentially from the pointed nose to advance the fastening peg into the pierced opening in the weatherseal upon rotation.

The fastening peg is preferably a one-piece, molded plastic construction for ease of assembly.

A method of attaching a weatherseal to a vehicle includes the steps of providing a fastening peg that pierces the weatherseal to form an opening therein and partially advancing the fastening peg through the weatherseal opening to secure the peg thereto.

The advancing step preferably includes rotating the fastening peg whereby the circumferential flange is advanced into the opening formed in the weatherseal.

A primary benefit of the invention is the ability to eliminate separate processing steps in securing a weatherseal to a vehicle.

Another benefit associated with the present invention is the reduced cost associated with the self-tapping fastening peg.

Still another advantage of the invention resides in the configuration of the fastening peg that makes it conducive to automated handling and assembly.

Still other benefits and advantages of the invention will become apparent to those skilled in the art upon a reading and understanding of the following detailed description.

### BRIEF DESCRIPTION OF THE DRAWINGS

FIG. 1A is an enlarged perspective view of the preferred embodiment of a fastening peg in accordance with the present invention.

FIG. 1B is an enlarged perspective view of an alternate embodiment of a fastening peg.

FIG. 2 is a plan view of a weatherseal to which fastening pegs are being secured.

FIG. 3 is an elevational view of a fastening peg adapted for insertion into a weatherseal.

FIG. 4 illustrates the fastening peg forming an opening in the weatherseal.

FIG. 5 shows a completed assembly of the fastening peg securing a weatherseal to a mounting surface.

### DETAILED DESCRIPTION OF THE INVENTION

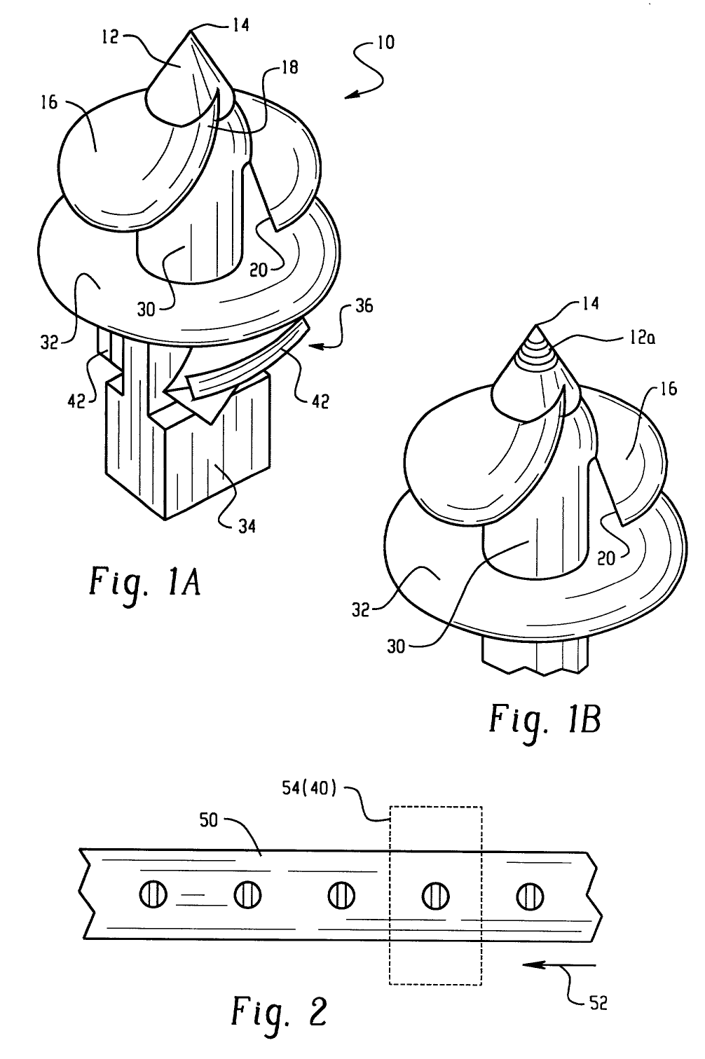

A self-tapping fastener or fastening peg 10 is shown in FIGS. 1A and 1B. For purposes of consistency and brevity, the following discussion will refer to like elements or components in the preferred embodiments of FIGS. 1A and 1B by like reference numerals, and any specific differences will be particularly identified. The fastening peg 10 of the present invention finds particular application in securing a weatherseal or weatherstrip to an automotive vehicle, and may find application in related applications and fields. A preferred embodiment of the fastening peg includes a pointed end or nose portion 12 that terminates in a sharp, conical point 14. In the first preferred embodiment of FIG. 1A, the nose portion has a smooth tapered conformation. However, it is also contemplated that the nose portion may adopt other conformations, for example, as illustrated in FIG. 1B. Here, the nose portion 12a includes tapered threads that terminate in a sharp conical point 14. The conical point is configured to pierce an elastomeric weatherseal upon axial and rotational advancement in a drilling-type action toward a mounting region of the weatherseal as will be described in greater detail below. A first flange or land 16 is spaced axially inward from the terminal conical point. The flange has a leading portion 18 that merges into the nose portion of the fastening peg. Particularly, the leading portion 18 spirals radially, circumferentially, and axially from the nose portion. The remainder of the flange 16 has a slight helical contour for reasons which will become more apparent below. The flange 16 has a generally constant diameter as it proceeds circumferentially over slightly greater than 180 degrees of its extent from the leading portion 18 and terminates in a radially extending shoulder 20 that is disposed approximately 180 to 720 degrees, and more preferably approximately 360 degrees, from where the leading portion 18 merges into the nose portion. A central shaft portion 30 axially interconnects the flange 16 in spaced relation with a second flange or shoulder 32. The second flange is preferably circumferentially continuous and has a constant diameter substantially larger than that of the shaft. The second flange serves as a washer or stop surface once the fastening peg is secured to the weatherseal.

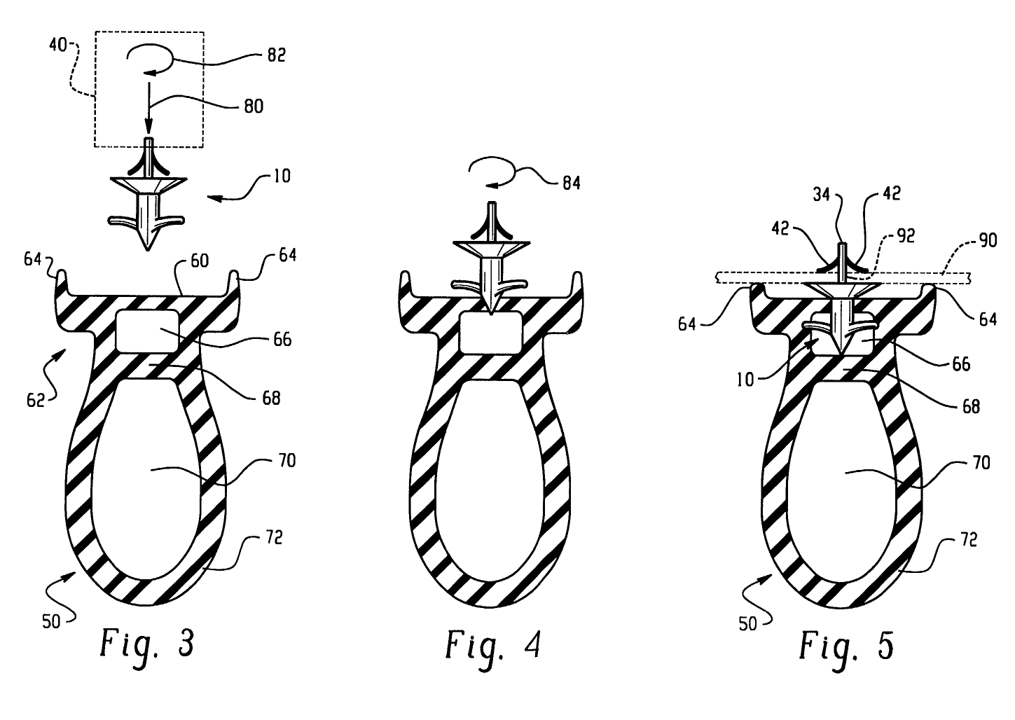

Extending outwardly from an opposite face of the second flange is a gripping shank 34 from which protrudes a locking assembly 36. The gripping shank 34 preferably has a parallelepiped conformation or another surface shape allowing the shank to be easily oriented and gripped by a clamp assembly associated with automated machinery. A clamp assembly is schematically illustrated in phantom 40 in FIG. 3. It will be appreciated by one skilled in the art that the clamp assembly can adopt a wide variety of structural and functional arrangements without departing from the scope and intent of the present invention. In the preferred arrangement, the locking assembly 36 includes first and second deflectable locking arms 42 that are disposed at an acute angle relative to a longitudinal axis of the fastening peg. An outer terminal end of each locking arm is disposed adjacent the flange 32 and spaced therefrom by a dimension that closely approximates a thickness of the associated mounting surface.

As schematically represented in FIG. 2, an elongated strip of elastomeric weatherseal 50 is selectively moved or indexed in the direction of arrow 52 to a first station 54. The first station includes automated fastening machinery 40, schematically represented in FIG. 3, that incrementally indexes the weatherseal to a position such that a generally planar surface 60 (FIG. 3) of the weatherseal is located at the fastener securing station 54. Once a fastening peg is mounted to the weatherseal (as will hereinafter detailed), the weatherseal is indexed leftwardly as shown in FIG. 2 to secure a separate fastener. The dimensional spacing between the fastening pegs is predetermined and may be varied for selective applications as will be understood by one skilled in the art.

Turning more particularly to FIGS. 3-5, the process of mounting a fastening peg to an elastomeric weatherseal without a pre-drilled or preformed opening is illustrated. The weatherseal 50 includes a base region 62 incorporating the planar surface 60. Upstanding longitudinal edges 64 extend outwardly from the planar surface and are adapted to sealingly engage a mounting surface (FIG. 5) once the weatherseal is secured thereto. A first or lower cavity 66 is typically formed in the base region. The first cavity is separated via rib 68 from a second cavity 70 formed in a bulbous seal portion 72 of the weatherseal. It is conventional that the weatherseal is a one-piece, extruded component, or may be a co-extruded component formed of desired elastomers, plastics, thermoplastics, etc.

A fastening peg 10 is engaged or carried by the clamp assembly 40, preferably along the gripping shank 34. The fastening peg is axially advanced toward the base region of the weatherseal as represented by reference arrow 80. As the pointed nose approaches the planar surface 60, the fastening peg is rotated at a first rotational velocity exemplified by reference numeral 82. The combined axial and rotational motion pierces the planar surface 60 and the conical point forms an opening and breaches the weatherseal for receipt within cavity 66. Continued rotation of the fastening peg after the pointed nose pierces through the weatherseal, for example at the same or a different rotational velocity as represented by reference numeral 84 in FIG. 4, advances the first flange 16 into the cavity 66. The leading edge 18 and the geometrical configuration of the first flange 16, that proceeds from the conical nose in an axial, radial, and circumferential fashion, urges the first flange through the opening. The shank 30 is tightly received in the opening when the first flange 16 is disposed within cavity 66 (FIG. 5) and the second flange 32 abuttingly engages the planar surface 60. Thus, the conical nose 12 initially pierces the planar surface and begins to spread the opening to permit further axial advancement of the fastening peg toward cavity 66. The elastomeric nature of the weatherseal permits the first flange to be progressively and rotationally received through the opening. The opening pierced in the weatherseal subsequently tightly engages about the shaft 30 whereby the fastening peg is securely mounted to the weatherseal. It will be further appreciated that the transverse dimension of the cavity 66 in a relaxed state is slightly less than the diameter of the first flange 16. This allows for predetermined compressive engaging forces exerted by the first flange on the weatherseal.

Once the fastening pegs have been secured to the weatherseal, the assembly is ready for attachment to a mounting surface 90 (FIG. 5). The mounting surface has pre-drilled or pre-formed openings dimensioned to receive the shank 34 of the fastener peg. As will be appreciated, axial advancement of the shank portion 34 of the fastening peg through the opening 92 in the mounting surface deflects the locking arms 42 inwardly toward the shank. Once the locking arms clear a rear surface or opening 92, the locking arms spring or flex outwardly to securely hold the weatherseal to the mounting surface. In that regard, legs 64 of the weatherseal sealingly engage along one face of the mounting surface and the enlarged radial dimension of the second flange 32 engages a second face of the mounting surface and serves as a stop surface during axial mounting of the fastener peg.

In the preferred embodiment, the fastening peg is a one-piece molded plastic component. It will be appreciated that composite assemblies may be formed without departing from teachings of the present invention. For example, the nose portion and piercing end 14 may be formed of one material that facilitates formation of an opening in the elastomeric weatherseal. The remainder of the fastener peg may be a different material that is secured thereto. Likewise, although the first and second flanges 16, 32 are illustrated as generally continuous surfaces, they may adopt different conformations or configurations, again, without departing from the teachings of the present invention.

In accordance with the preferred method of attaching the weatherseal to a mounting surface such as an automotive vehicle, the fastening peg initially pierces the weatherseal to form an opening. The fastening peg is then partially advanced through the weatherseal opening. The advancing step preferably includes rotating the fastening peg to advance the first flange through the pierced opening. Higher velocity rotation is preferably used for the piercing operation and the rotational velocity subsequently reduced to advance the first flange through the opening, although it will be understood that different velocity profiles may be used in certain instances, e.g., low velocity followed by high velocity, or the same velocity may be used in the piercing and advancing steps. Subsequently, the method includes the step of securing the fastener in an opening to attach the weatherseal to a mounting surface of the vehicle. More particularly, the vehicle securing step includes axially advancing the fastener into a vehicle opening. As also described above, a shank portion of fastener peg is preferably gripped and the fastening peg axially advanced and rotated to pierce and form the opening in the weatherseal.

The invention has been described with reference to the preferred embodiment. Obviously, modifications and alterations will occur to others upon a reading and understanding of the present invention. It is intended to include all such modifications and alterations insofar as they come within the scope of the appended claims or the equivalents thereof.

What is claimed is:

1. A self-tapping fastening peg for securing a weatherseal to a vehicle, the fastening peg comprising:
a pointed nose adapted to pierce an associated weatherseal;
a helical flange substantially circumscribing the nose;
a shoulder axially spaced from the flange; and
a locking assembly disposed adjacent the shoulder and adapted to secure the fastening peg to an associated vehicle.

2. The fastening peg of claim 1 wherein the pointed nose includes a thread.

3. The fastening peg of claim 1 wherein the pointed nose is conically shaped for piercing and advancing through an associated weatherseal.

4. The fastening peg of claim 1 wherein the helical flange includes a leading portion that spirals radially and circumferentially outward from the pointed nose.

5. The fastening peg of claim 4 wherein the leading portion merges into the pointed nose at a location spaced axially inward from a terminal end of the pointed nose.

6. The fastening peg of claim 5 wherein the leading portion proceeds axially away from the terminal end as it spirals outwardly.

7. The fastening peg of claim 1 wherein the helical flange merges into the pointed nose at a location spaced axially inward from a terminal end of the pointed nose.

8. The fastening peg of claim 1 wherein the helical flange includes a leading portion that spirals axially, radially and circumferentially from the pointed nose.

9. The fastening peg of claim 8 wherein the helical flange terminates in a radial edge.

10. The fastening peg of claim 9 wherein the radial edge is located approximately 360 from where the helical flange merges into the pointed nose.

11. A molded plastic fastening peg adapted to form an opening in an elastomeric weatherseal and secure the weatherseal to a vehicle, the fastening peg comprising:
a nose portion at a first end terminating in a piercing conical point;
a flange spaced axially from the conical point and including a leading portion that extends axially from adjacent the nose portion;
a circumferentially continuous shoulder axially spaced from the flange; and
a locking assembly spaced on an axial opposite side of the shoulder from the flange.

12. The fastening peg of claim 11 wherein the leading portion radially, axially, and circumferentially merges into the nose portion.

13. The fastening peg of claim 12 wherein the leading portion merges into the nose portion at a region axially spaced from the conical point.

14. The fastening peg of claim 11 wherein the locking assembly includes first and second flexible arms extending radially outward.

15. The fastening peg of claim 11 further comprising a base configured for handling by automated machinery.

16. A method of attaching a weatherseal to a vehicle comprising the steps of:
providing a fastening peg;
piercing the weatherseal with the fastening peg to form an opening in the weatherseal; and
partially advancing the fastening peg through the weatherseal opening.

17. The method of claim 16 wherein the advancing step includes rotating the fastening peg.

18. The method of claim 16 comprising the further step of securing the fastener in an opening formed in the vehicle.

19. The method of claim 18 wherein the securing step includes axially advancing the fastener in the vehicle opening.

20. The method of claim 16 comprising the further step of mechanically gripping one end of the fastening peg.
